(19) United States
(12) Patent Application Publication
(10) Pub. No.: US 2022/0134721 A1
(43) Pub. Date: May 5, 2022

(54) CONDUCTIVE CARBON FIBER REINFORCED COMPOSITE AND METHOD OF FORMING THEREOF

(71) Applicant: Agency for Science, Technology and Research, Singapore (SG)

(72) Inventors: Warintorn THITSARTARN, Singapore (SG); Siok Wei TAY, Singapore (SG); Qi Feng LIM, Singapore (SG); Chaobin HE, Singapore (SG)

(21) Appl. No.: 17/435,237

(22) PCT Filed: Mar. 5, 2020
(86) PCT No.: PCT/SG2020/050104

§ 371 Date: Aug. 31, 2021

(30) Foreign Application Priority Data
Mar. 6, 2019 (SG) 10201901997Y

(51) Int. Cl. B32B 27/12; B32B 5/02; D06M 11/83; C08J 5/24; C08K 3/04; C08K 3/08; H01B 1/22; H01B 1/24

(52) U.S. Cl. CPC B32B 27/12; B32B 5/02; D06M 11/83; C08J 5/248; D06M 2101/40; C08K 3/041; C08K 3/08; H01B 1/22; H01B 1/24; C08J 5/249

(57) ABSTRACT

A conductive carbon fiber reinforced composite comprising: a metal-coated carbon fiber fabric laminated with a nanocomposite resin, the nanocomposite resin comprising a mixture of: a polymerizable thermosetting polymer, a conductive filler, and a carbonaceous fiber-like filler. A method of forming a conductive carbon fiber reinforced composite, the composite comprising a metal-coated carbon fiber fabric laminated with a nanocomposite resin, the nanocomposite resin comprising a mixture of: a polymerizable thermosetting polymer, a conductive filler, and a carbonaceous fiber-like filler, the method comprising the steps of:
a) forming the nanocomposite resin;
b) forming the metal-coated carbon fiber fabric; and
c) laminating the metal-coated carbon fiber fabric with the nanocomposite resin using one of: a wet lay-up process followed by hot-press curing under vacuum, a vacuum infusion process, a prepreg fabrication process, and a resin transfer molding process.

This invention relates to a conductive carbon fiber reinforced composite and method of forming thereof.

### BACKGROUND

Utilization of carbon fiber reinforced polymer (CFRP) has increased significantly over the years. However, one of the drawbacks of CFRP has been its lack of lack of electrical conductivity which is crucial especially for the aerospace industry and particularly to protect against lightning strikes. Many developments have been made to improve the electrical conductivity of CFRP, one of which is a multi-layered CFRP with an electrically conductive top layer. This is composed of metal foils or mesh as a conductive layer adhered on top of CFRP using conductive glues or sealants. However, it is known that the metal conductive layer is relatively heavy, up to 0.5 tons per aeroplane, and is also susceptible to corrosion. There is therefore a demand for a lightweight and conductive material for use in the aerospace industry that can reduce cost by reducing weight and therefore lowering fuel utilization and that is also more corrosion resistant.

### SUMMARY

According to a first aspect, there is provided a conductive carbon fiber reinforced composite comprising: a metal-coated carbon fiber fabric laminated with a nanocomposite resin, the nanocomposite resin comprising a mixture of: a polymerizable thermosetting polymer, a conductive filler, and a carbonaceous fiber-like filler.

The carbonaceous fiber-like filler may be modified with one of: a metal and a metal oxide.

The metal may be at least one of: silver, copper and nickel.

The carbonaceous fiber-like filler may comprise one of: organo-silane functionalized carbon fibers and metal-decorated organo-silane functionalized carbon fibers.

The carbon fibers may comprise at least one of: single-walled carbon nanotubes, multi-walled carbon nanotubes and thin multi-walled carbon nanotubes.

Percentage by weight of the carbonaceous fiber-like filler in the nanocomposite resin may range from 0.5% to 10%.

The conductive filler may comprise particles of at least one of: metal and metal oxide.

The particles may comprise at least one of: nanoparticles and wire-shaped microparticles.

The conductive filler may include metal clusters.

Material of the conductive filler may comprise at least one of: silver, nickel, copper and platinum.

Percentage by weight of the conductive filler in the nanocomposite resin may range from 0.5% to 20%.

Weight ratio of the polymerizable thermosetting polymer to the conductive filler and to the carbonaceous fiber-like filler in the nanocomposite resin may be 1:0.05:0.008. The polymerizable thermosetting polymer may comprise an epoxy polymer having a plurality of epoxide groups.

The metal-coated carbon fiber fabric may comprise a woven carbon fiber fabric coated with a coating comprising at least one of: silver, nickel, copper, indium and gold.

The coating may have a thickness of up to 400 nm.

Percentage by weight of the coating in the metal-coated carbon fiber fabric may range from 1% to 30%.

Percentage by weight of the metal-coated carbon fiber fabric in the conductive carbon fiber reinforced composite may range from 65% to 75%.

According to a second aspect, there is provided a method of forming a conductive carbon fiber reinforced composite, the composite comprising a metal-coated carbon fiber fabric laminated with a nanocomposite resin, the nanocomposite resin comprising a mixture of: a polymerizable thermosetting polymer, a conductive filler, and a carbonaceous fiber-like filler, the method comprising the steps of:
a) forming the nanocomposite resin;
b) forming the metal-coated carbon fiber fabric; and
c) laminating the metal-coated carbon fiber fabric with the nanocomposite resin using one of: a wet lay-up process followed by hot-press curing under vacuum, a vacuum infusion process, a prepreg fabrication process, and a resin transfer molding process.

Forming the metal-coated carbon fiber fabric may comprise depositing a coating by electroless deposition of at least one of: silver, nickel, copper, indium and gold on a carbon fiber fabric.

Forming the nanocomposite resin may comprise:
i. dispersing the conductive filler in ethanol and stirring to form a first suspension,
ii. dispersing the carbonaceous fiber-like filler in ethanol followed by adding aminopropyltrimethoxysilane and followed by stirring to form a second suspension,
iii. adding the first suspension and the second suspension to the polymerizable thermosetting polymer to form a mixture,
iv. homogenizing the mixture,
v. removing ethanol from the mixture under vacuum,
vi. adding hardener to the mixture to form the nanocomposite resin, and
vii. degassing the nanocomposite resin.

### BRIEF DESCRIPTION OF FIGURES

In order that the invention may be fully understood and readily put into practical effect there shall now be described by way of non-limitative example only exemplary embodiments of the present invention, the description being with reference to the accompanying illustrative drawings.

FIG. 1 is a schematic cross-sectional illustration of a conductive carbon fiber reinforced composite.

FIG. 2 is a schematic illustration of a nanocomposite resin in the conductive carbon fiber reinforced composite.

FIG. 3 is a focused ion beam image of a cross-section of a single strand of a metal coated carbon fiber.

FIG. 4 is a flow chart of an exemplary method to form the conductive carbon fiber reinforced composite.

### DETAILED DESCRIPTION

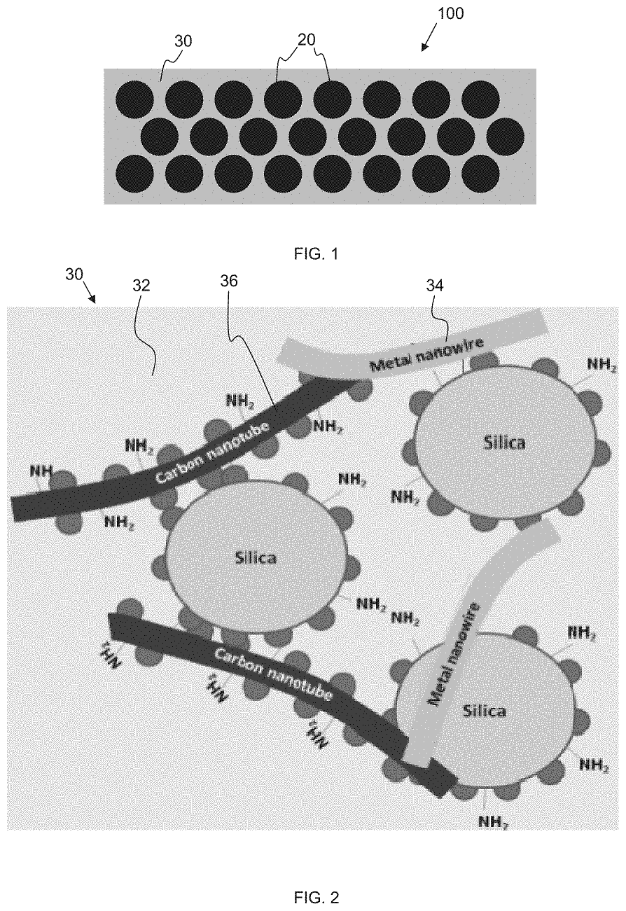

Exemplary embodiments of a conductive carbon fiber reinforced composite 100 and method 200 of forming the same 100 will be described below with reference to FIGS. 1 to 4. The same reference numerals are used across the figures to refer to the same or similar parts.

As shown in FIG. 1, the conductive carbon fiber reinforced composite 100 comprises a metal-coated carbon fiber fabric 20 laminated with a nanocomposite resin 30.

The nanocomposite resin 30 comprises a mixture of a polymerizable thermosetting polymer 32, a conductive filler 34, and a carbonaceous fiber-like filler 36, as can be seen in FIG. 2.

The polymerizable thermosetting polymer 32 may be selected from a group of epoxy resins. The epoxy resins may be epoxy resins aliphatic, cycloaliphatic or aromatic epoxy resins, and may having a plurality of epoxide groups. In an exemplary embodiment, a commercially-available epoxy resin may be used, such as D.E.R™ 332 by Dow Chemicals. A crosslinking agent for the epoxy resin may be selected from a group of diamine compounds. The crosslinking agents may be aliphatic or aromatic diamine compounds which have a plurality of amine groups. In an exemplary embodiment, a commercially-available curing agent may used, such as ETHACURE® 100-LC hardener from Albemarle®, with a weight ratio of epoxy resin to curing agent of 100 to 26.2. In an exemplary embodiment, weight ratio of the polymerizable thermosetting polymer 32 to the conductive filler 34 and to the carbonaceous fiber-like filler 36 in the nanocomposite resin 30 is 1:0.05:0.008.

The conductive filler 34 comprises particles of at least one metal and/or metal oxide. The at least one metal is an electrically conductive metal and may comprise silver, nickel, copper and/or platinum. The particles may be nanoparticles and/or wire-shaped microparticles of about 150 nm in diameter and greater than 5 microns in length. The conductive filler 34 may also comprise metal clusters of various sizes. In an exemplary embodiment, the conductive filler 34 comprise copper and nickel nanoparticles. Percentage by weight of the conductive filler 34 in the nanocomposite resin 30 ranges from 0.5% to 20%.

The carbonaceous fiber-like filler 36 may be modified with a metal oxide or a metal or combination of metals such as silver, copper and/or nickel. The carbonaceous fiber-like filler 36 may comprise organo-silane functionalized carbon fibers and/or metal-decorated organo-silane functionalized carbon fibers. The carbon fibers may comprise single-walled carbon nanotubes, multi-walled carbon nanotubes and/or thin multi-walled carbon nanotubes. In an exemplary embodiment, the carbon fibers comprise thin multi-walled carbon nanotubes. Percentage by weight of the carbonaceous fiber-like filler 36 in the nanocomposite resin 30 ranges from 0.5% to 10%.

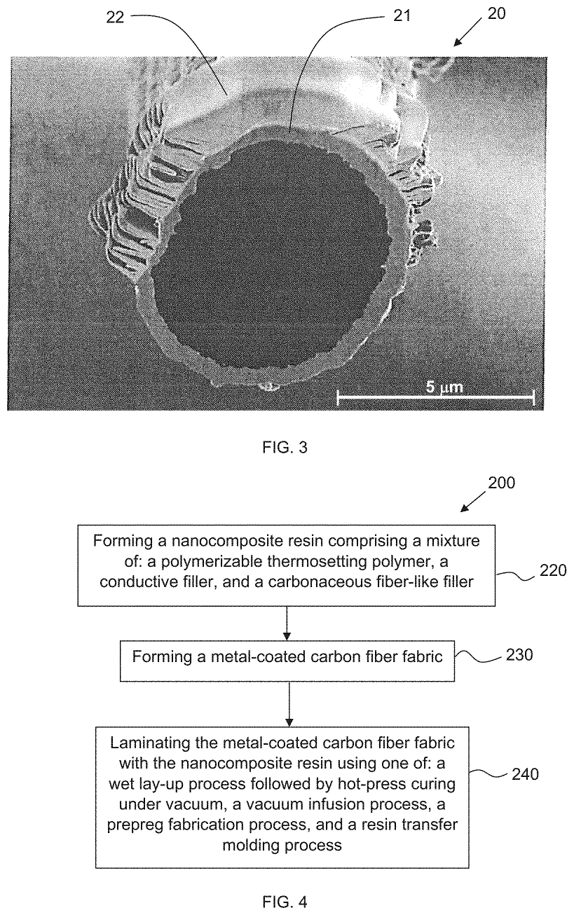

The metal-coated carbon fiber fabric 20 comprises a woven carbon fiber fabric 21 coated with a metal coating 22. The metal coating 22 may comprise a metal or a metal alloy, and may comprise silver, nickel, nickel phosphorous, copper, indium and/or gold. FIG. 3 shows a single strand 20 of carbon fiber 21 coated with copper or nickel-phosphorous 22. The metal coating 22 may have a thickness of up to 400 nm. Percentage by weight of the metal coating 22 in the metal-coated carbon fiber fabric 20 ranges from 1% to 30%. Percentage by weight of the metal-coated carbon fiber fabric 20 in the conductive carbon fiber reinforced composite 100 ranges from 65% to 75%.

Method of Forming

As depicted in FIG. 4, a method 200 of forming the conductive carbon fiber reinforced composite 100 comprises forming the nanocomposite resin 30 (220), forming the metal-coated carbon fiber fabric 20 (230), and laminating the metal-coated carbon fiber fabric 20 with the nanocomposite resin 30 (240) using one of: a wet lay-up process followed by hot-press curing under vacuum, a vacuum infusion process, a prepreg fabrication process, or a resin transfer molding process, as will be described in greater detail below.

The metal-coated carbon fiber fabric 20 may be formed by depositing a coating of silver, nickel, nickel-phosphorous, copper, indium and/or gold 22 on a woven carbon fiber fabric 21 (e.g. Toray T300) by electroless deposition. Electroless deposition is a well-established method used in many industries such as the semi-conductor industry. In this way, a layer of metal or metal alloy 22 can be deposited onto the carbon fiber fabric 21 in a wet solution method enabling easy adoption by industry. In an exemplary embodiment of the method 200, woven carbon fiber fabric 21 is first immersed into a palladium-tin activating solution for 8 min, and then washed using 3.7 wt % hydrochloric acid and deionized (DI) water. It was then immersed into an electroless nickel bath solution set at 90° C. and at a pH of 5. The carbon fiber fabric 21 was plated by electroless deposition for 10 minutes before it was removed, washed using DI water and dried in an vacuum oven. In an alternative embodiment, copper 22 may be electrolessly plated onto carbon fiber fabric 21 using the same activation process as that for nickel plating but the copper electroless bath is kept at room temperature. Electroless nickel bath with high phosphorus content (11 wt %) may alternatively be used for the fabrication of high-phosphorous nickel or nickel-phosphorous coating 22 on carbon fiber fabric 21. The amount of metal coating 22 is kept low, preferably below 30%, in order to keep the increment in weight low. The thickness of the coating 22 is kept below 400 nm in thickness.

Forming the nanocomposite resin 30 may in general comprise dispersing the conductive filler 34 in ethanol and stirring to form a first suspension, dispersing the carbonaceous fiber-like filler 36 in ethanol followed by adding aminopropyltrimethoxysilane and followed by stirring to form a second suspension, adding the first suspension and the second suspension to the polymerizable thermosetting polymer 32 to form a mixture, homogenizing the mixture, removing ethanol from the mixture under vacuum, adding hardener to the mixture to form the nanocomposite resin 30, and degassing the nanocomposite resin 30.

In an exemplary embodiment of forming the nanocomposite resin 30, metal nanoparticles 34 at 10 wt % with respect to weight of the nanocomposite resin 30 were dispersed in an alcohol solvent such as ethanol using an ultrasonicator for at least 3 minutes, followed by overnight stirring, to form a first suspension.

Carbon nanotubes (CNTs) 36 at 1 wt % with respect to weight of the nanocomposite resin 30 were dispersed in ethanol using an ultrasonicator for at least 30 min, followed by overnight stirring. Aminopropyltrimethoxysilane (APTMS) was then added at 20 wt % with the respect to the weight of the CNTs to form a second suspension. The second suspension was mixed under vigorous stirring at 75° C. After 4 hours of reaction time, the second suspension was cooled down to ambient temperature.

The first suspension and the second suspension were then added into epoxy resin 32 and the entire mixture homogenized for at least 30 minutes. The ethanol solvent was then removed from the mixture under vacuum at 75° C. After the mixture has cooled down to room temperature, the mixture was gently mixed with the hardener to form the nanocomposite resin 30. The weight ratio of the mixture and the hardener was 1:0.26.

The nanocomposite resin 30 was then degassed and ready for use in a lamination process with the metal-coated carbon fiber fabric 20 to form the conductive carbon fiber reinforced composite 100.

In an exemplary lamination process, the nanocomposite resin 30 may be laminated on the metal-coated carbon fiber fabric 20 using a wet lay-up process to obtain multiple piles of metal-coated carbon fiber 20 followed by a hot-pressed and vacuum curing process to obtain a composite 100 having multiple piles of metal-coated carbon fiber 20 therein. In an exemplary embodiment, the nanocomposite resin 30 formed as described above is laminated onto the metal-coated carbon fiber fabric 20 using a wet lay-up process where fiber content in the uncured laminate is 70±3 wt %. The uncured laminate is then put into a vacuum bagging which connects to a quick-disconnect set for the hot-press vacuum curing process. In the hot-pressed vacuum curing process, the vacuum bagging containing the uncured laminate is pressed between two plates of a hot press machine (e.g. Labtech LP25M supplied by Labquip Pte Ltd) while applying vacuum to the laminate in the vacuum bagging. Pressure between the two plates is slowly increased from 0 to 2 bars at 25° C. and maintained at a constant pressure of 2 bars before increasing the curing temperature (e.g. at a rate of 3-5° C./min) to a set point temperature (e.g. 160° C.) and holding at the set point temperature for 1 hour. After that, the temperature was raised to 180° C. for 4 hrs. The cured laminate was then depressurized and cooled down to room temperature, followed by post-curing at 230° C. for 4 hrs.

Alternatively, the lamination may be performed with an infusion process, using a prepreg method or resin transfer molding.

Electrical Conductivity

Table 1 below shows the electrical conductivity of various components that may be comprised in the conductive carbon fiber reinforced composite 100 as well as of carbon fiber 21, epoxy resin 32 and copper mesh provided for comparison.

TABLE 1

| | | Electrical |
|---|---|---|
| Component | Composition | Conductivity (S/cm) |
| Carbon fiber coated with | Carbon, nickel | 10,563 ± 245.5 |
| nickel | | |
| Carbon fiber coated with | Carbon, copper | 47,486 ± 526.2 |
| copper | | |
| Carbon fiber coated with | Carbon, nickel, copper | 23,845 ± 125.6 |
| nickel-copper alloy | | |
| Nanocomposite resin | Epoxy resin, treated thin- | 0.48 ± 0.05 |
| | walled carbon nanotubes, | |
| | nickel and copper | |
| | nanoparticles | |
| Carbon fiber * | Carbon | 626.5 ± 50.4 |
| Neat resin * | Epoxy resin | 6.5 × 10⁻¹⁵ |
| Copper mesh * | Copper | 56,439 ± 106.4 |

* provided for comparison

As can be seen from Table 1, electrical conductivity of carbon fiber 21 coated with nickel and or copper 22 and the nanocomposite resin 30 that may be comprised in the conductive carbon fiber reinforced composite 100 are significantly higher than uncoated carbon fiber 21 and neat epoxy resin 32 respectively. Coated carbon fibers 20 are ten to seventy times more conductive than pristine or uncoated carbon fibers 21, and the nanocomposite resin 30 was 10¹⁴ times more conductive than neat epoxy resin 32.

The electrical conductivity of different examples of the conductive carbon fiber reinforced composite 100 were studied, as well as that of a carbon fiber reinforced resin composite and a carbon fiber reinforced resin composite having a top layer of copper mesh as comparative examples. The different examples studied comprised:
Example 1: Nickel-coated carbon fiber fabric 20 laminated with the nanocomposite resin 30 (comprising organo-silane functionalized carbon fiber 36 and metal nanoparticles 34) to have a top layer of the nickel-coated carbon fiber fabric 20 and cured using a hot-pressed and vacuum curing process as described above to obtain 16 piles of nickel-coated carbon fiber fabric 20
Example 2: Copper-coated carbon fiber fabric 20 laminated with the nanocomposite resin 30 (comprising organo-silane functionalized carbon fiber 36 and metal nanoparticles 34) to have a top layer of the copper-coated carbon fiber fabric 20 and cured using a hot-pressed and vacuum curing process as described above to obtain 16 piles of copper-coated carbon fiber fabric 20
Example 3: Nickel and copper-coated carbon fiber fabric 20 laminated with the nanocomposite resin 30 (comprising organo-silane functionalized carbon fiber 36 and metal nanoparticles 34) to have a top layer of the nickel- and copper-coated carbon fiber fabric 20 and cured using a hot-pressed and vacuum curing process as described above to obtain 16 piles of nickel- and copper-coated carbon fiber fabric 20
Comparative Example A: Woven carbon fiber fabric (Toray T300) laminated with neat epoxy resin (mixed with hardener at weight ratio of 1:0.26). The neat epoxy resin was applied onto the woven carbon fiber fabric using a wet lay-up process to obtain 16 piles of carbon fiber fabric and cured using a hot-pressed and vacuum process as described above
Comparative Example B (commercial benchmark): Woven carbon fiber fabric (Toray T300) laminated with neat epoxy resin (mixed with hardener at weight ratio of 1:0.26) and having a copper mesh layer as the top layer. The neat epoxy resin was applied onto the woven carbon fiber using a wet lay-up process to obtain a 16 piles of carbon fiber fabric and a commercially available copper mesh (Dexmet 2CU4-100A) was placed on top of the uncured laminate followed by curing using a hot-pressed and vacuum process as described above

The bulk electrical conductivity of the examples described above was evaluated at room temperature using a four-probe resistivity meter (Loresta-AX MCP-T370) and converting to bulk electrical conductivity value, according to the ASTM Standard 0257. In addition, the electrical conductivity of the fiber bundle was measured using the method mentioned in the publication of Wang et. al., (RSC Adv., 2016, 6, 14016-14026).

Table 2 below shows the obtained electrical conductivity of the examples described above.

TABLE 2

| | Electrical | Electrical |
|---|---|---|
| | Resistivity, | Conductivity, |
| Sample | Surface (Ω/sq) | Bulk (S/cm) |
| Example 1 | 1.23 ± 0.2 × 10⁻² | 81.3 ± 5.2 |
| Example 2 | 7.70 ± 0.1 × 10⁻³ | 129.9 ± 10.5 |
| Example 3 | 7.69 ± 0.3 × 10⁻³ | 130.2 ± 15.2 |
| Comparative Example A | 2.89 ± 0.2 | 2.88 ± 0.4 |
| Comparative Example B | 2.60 ± 0.6 × 10⁻⁴ | 3.13 ± 1.6 |

As can be seen from Table 2, the developed conductive carbon fiber reinforced composite 100, especially examples 2 and 3, had obviously low electrical resistivity (high conductivity) compared to comparative example A (reference). The surface resistivity was also lower than comparative example B (a commercial benchmark) by about one order. For bulk conductivity, it is obvious that the developed conductive carbon fiber reinforced composite 100 had significantly high conductivity (about one to two orders), as compared to reference and benchmark. The result indicate that it is highly possible to fabricate conductive carbon fiber reinforced composite 100 without using any copper mesh and that the composite 100 can be used for extreme applications such as lightning strike protection.

The above-disclosed conductive carbon fiber reinforced composite 100 is shown to have high electrical conductivity and improved performance on shielding efficiency. The composite 100 has high conductivity without the inclusion of a metal conductive layer. Instead, conductivity and shielding efficiently come from both the metal-coated carbon fiber fabric 20 and the nanocomposite resin 30 with which it is laminated. Without the metal conductive layer used in prior art composites, the weight of the present composite 100 is reduced, while retaining its performance to withstand harsh environments. Corrosion susceptibility is also diminished.

Whilst there has been described in the foregoing description exemplary embodiments of the present invention, it will be understood by those skilled in the technology concerned that many variations and combination in details of design, construction and/or operation may be made without departing from the present invention.

1. A conductive carbon fiber reinforced composite comprising:
a metal-coated carbon fiber fabric laminated with a nanocomposite resin, the nanocomposite resin comprising a mixture of: a polymerizable thermosetting polymer, a conductive filler, and a carbonaceous fiber-like filler.

2. The conductive carbon fiber reinforced composite of claim 1, wherein the carbonaceous fiber-like filler is modified with one of: a metal and a metal oxide.

3. The conductive carbon fiber reinforced composite of claim 2, wherein the metal is at least one of: silver, copper and nickel.

4. The conductive carbon fiber reinforced composite of claim 2, wherein the carbonaceous fiber-like filler comprises one of: organo-silane functionalized carbon fibers and metal-decorated organo-silane functionalized carbon fibers.

5. The conductive carbon fiber reinforced composite of claim 3, wherein the carbon fibers comprise at least one of: single-walled carbon nanotubes, multi-walled carbon nanotubes and thin multi-walled carbon nanotubes.

6. The conductive carbon fiber reinforced composite of claim 1, wherein percentage by weight of the carbonaceous fiber-like filler in the nanocomposite resin ranges from 0.5% to 10%.

7. The conductive carbon fiber reinforced composite of claim 1, wherein the conductive filler comprises particles of at least one of: metal and metal oxide.

8. The conductive carbon fiber reinforced composite of claim 7, wherein the particles comprise at least one of: nanoparticles and wire-shaped microparticles.

9. The conductive carbon fiber reinforced composite of claim 7, wherein the conductive filler includes metal clusters.

10. The conductive carbon fiber reinforced composite of claim 7, wherein material of the conductive filler comprises at least one of: silver, nickel, copper and platinum.

11. The conductive carbon fiber reinforced composite of claim 1, wherein percentage by weight of the conductive filler in the nanocomposite resin ranges from 0.5% to 20%.

12. The conductive carbon fiber reinforced composite of claim 1, wherein weight ratio of the polymerizable thermosetting polymer to the conductive filler and to the carbonaceous fiber-like filler in the nanocomposite resin is 1:0.05:0.008.

13. The conductive carbon fiber reinforced composite of claim 1, wherein the polymerizable thermosetting polymer comprises an epoxy polymer having a plurality of epoxide groups.

14. The conductive carbon fiber reinforced composite of claim 1, wherein the metal-coated carbon fiber fabric comprises a woven carbon fiber fabric coated with a coating comprising at least one of: silver, nickel, copper, indium and gold.

15. The conductive carbon fiber reinforced composite of claim 14, wherein the coating has a thickness of up to 400 nm.

16. The conductive carbon fiber reinforced composite of claim 14, wherein percentage by weight of the coating in the metal-coated carbon fiber fabric ranges from 1% to 30%.

17. The conductive carbon fiber reinforced composite of claim 1, wherein percentage by weight of the metal-coated carbon fiber fabric in the conductive carbon fiber reinforced composite ranges from 65% to 75%.

18. A method of forming a conductive carbon fiber reinforced composite, the composite comprising a metal-coated carbon fiber fabric laminated with a nanocomposite resin, the nanocomposite resin comprising a mixture of: a polymerizable thermosetting polymer, a conductive filler, and a carbonaceous fiber-like filler, the method comprising the steps of:
a) forming the nanocomposite resin;
b) forming the metal-coated carbon fiber fabric; and
c) laminating the metal-coated carbon fiber fabric with the nanocomposite resin using one of: a wet lay-up process followed by hot-press curing under vacuum, a vacuum infusion process, a prepreg fabrication process, and a resin transfer molding process.

19. The method of claim 18, wherein forming the metal-coated carbon fiber fabric comprises depositing a coating by electroless deposition of at least one of: silver, nickel, copper, indium and gold on a carbon fiber fabric.

20. The method of claim 18, wherein step a) comprises:
i. dispersing the conductive filler in ethanol and stirring to form a first suspension,
ii. dispersing the carbonaceous fiber-like filler in ethanol followed by adding aminopropyltrimethoxysilane and followed by stirring to form a second suspension,
iii. adding the first suspension and the second suspension to the polymerizable thermosetting polymer to form a mixture,
iv. homogenizing the mixture,
v. removing ethanol from the mixture under vacuum,
vi. adding hardener to the mixture to form the nanocomposite resin, and
vii. degassing the nanocomposite resin.
